(19) United States
(12) Patent Application Publication
(10) Pub. No.: US 2007/0282687 A1
(43) Pub. Date: Dec. 6, 2007

(54) METHOD AND APPARATUS FOR REDEEMING AN ECONOMIC INCENTIVE

(75) Inventor: Edward W. Laves, Golden, CO (US)

Correspondence Address: COOLEY GODWARD KRONISH LLP;ATTN: Patent Group, Suite 1100, 777 - 6th Street, NW, WASHINGTON, DC, 20001, US

(73) Assignee: NewsFlex, Ltd., Golden, CO (US)

(21) Appl. No.: 11/756,500

(22) Filed: May 31, 2007

Related U.S. Application Data
(60) Provisional application No. 60/809,911, filed on Jun. 1, 2006.

(51) Int. Cl. G06Q 30/00

(52) U.S. Cl. 705/14

(57) ABSTRACT

A method and apparatus for redeeming an economic incentive is described. One illustrative embodiment receives in a portable electronic device an economic incentive associated with a merchant; displays the economic incentive on a display of the portable electronic device; and transmits over a network a message from the portable electronic device to a computer associated with the merchant in response to a user's selection of the displayed economic incentive, the message indicating a request by the user for the economic incentive to be applied to a user purchase automatically by a point-of-sale computer of the merchant upon authentication of the user by the point-of-sale computer during a subsequent visit of the user to a store of the merchant.

### PRIORITY

The present application claims priority from commonly owned and assigned Application No. 60/809,911, Attorney Docket No. NEWF-001/00US, entitled “Method and Apparatus for Using an Electrophoretic Display to Display the Content of a Newspaper,” filed on Jun. 1, 2006, which is incorporated herein by reference in its entirety.

### RELATED APPLICATIONS

The present application is related to commonly owned and assigned application Ser. No. (unassigned), Attorney Docket No. NEWF-001/01US, entitled “Apparatus and Method for Displaying Content on a Portable Electronic Device,” filed herewith.

### FIELD OF THE INVENTION

The present invention relates generally to electronic commerce. In particular, but not by way of limitation, the present invention relates to methods for redeeming an economic incentive and to portable electronic apparatuses for carrying out such methods.

### BACKGROUND OF THE INVENTION

Merchants, whether on-line or operating from brick-and-mortar stores, frequently offer coupons or other economic incentives to consumers. Such economic incentives are typically redeemed in one of two fashions. In the longstanding traditional approach, the customer clips a paper coupon from a newspaper or other publication and presents it at checkout in a physical store to receive the associated discount. In modern on-line shopping, a consumer may apply a coupon at checkout when shopping at a virtual store by entering a code or other identifier associated with the on-line coupon.

Both of these conventional approaches have at least two disadvantages. First, the consumer must keep track of the offered economic incentive until the consumer is ready to redeem the economic incentive. Often, the consumer first encounters the economic incentive at a time when it is not possible for the consumer to visit a physical or on-line store to take advantage of it. By the time the user has an opportunity to redeem the economic incentive, the consumer may discover that he or she has misplaced or mistakenly discarded the economic incentive. Second, the user must remember to present the coupon at checkout to receive the benefit of the economic incentive. This is especially troublesome if the consumer must carry a physical coupon or other economic incentive to a physical store. Even if the consumer remembers to take the economic incentive to the store, he or she might still forget to present it to the cashier at checkout.

It is thus apparent that there is a need in the art for an improved method and apparatus for redeeming an economic incentive.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and apparatus for redeeming an economic incentive. One illustrative embodiment is a method, comprising receiving in a portable electronic device an economic incentive associated with a merchant; displaying the economic incentive on a display of the portable electronic device; and transmitting over a network a message from the portable electronic device to a computer associated with the merchant in response to a user's selection of the displayed economic incentive, the message indicating a request by the user for the economic incentive to be applied to a user purchase automatically by a point-of-sale computer of the merchant upon authentication of the user by the point-of-sale computer during a subsequent visit of the user to a store of the merchant.

Another illustrative embodiment is a portable electronic device, comprising a display; a processor; at least one communication interface; and a plurality of program instructions stored in a memory and executable by the processor that are configured to cause the processor to (i) receive, via the at least one communication interface, an economic incentive associated with a merchant; (ii) display the economic incentive on the display; and (iii) transmit over a network a message from the portable electronic device to a computer associated with the merchant in response to a user's selection of the displayed economic incentive, the message indicating a request by the user for the economic incentive to be applied to a user purchase automatically by a point-of-sale computer of the merchant upon authentication of the user by the point-of-sale computer during a subsequent visit of the user to a store of the merchant.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIGS. 1A-1D are illustrations of a foldable multi-panel display of a portable electronic device in various configurations in accordance with an illustrative embodiment of the invention;

FIG. 2 is an illustration of a portable electronic device that includes a control module with input buttons by which a user can control the portable electronic device in accordance with an illustrative embodiment of the invention;

FIG. 3 is a high-level block diagram of a portable electronic device in accordance with an illustrative embodiment of the invention;

FIG. 4 is a high-level block diagram of a portable electronic device that includes a touch-sensitive display in accordance with another illustrative embodiment of the invention;

FIG. 5 is an illustration of a portable electronic device that includes a rocker switch by which a user can reposition content displayed on the portable electronic device in accordance with an illustrative embodiment of the invention;

FIG. 6 is a high-level diagram of an environment in which a portable electronic device is connected with a network server and database in accordance with an illustrative embodiment of the invention;

FIG. 7 is a high-level diagram of an environment in which a portable electronic device is connected with a local printer, a remote merchant location, or both in accordance with an illustrative embodiment of the invention;

FIG. 8 is a flowchart of a method for displaying and advancing content on a portable electronic device in accordance with an illustrative embodiment of the invention;

FIG. 9 is a flowchart of a method for obtaining new content to be displayed on a portable electronic device in accordance with an illustrative embodiment of the invention;

FIG. 10 is a flowchart of a method for enlarging, in response to input from a user, content displayed on a portable electronic device in accordance with an illustrative embodiment of the invention;

FIG. 11 is a flowchart of a method for processing, in a portable electronic device, a request from a user to redeem an economic incentive from a merchant in accordance with an illustrative embodiment of the invention;

FIG. 12 is a flowchart of a method for processing, in a merchant's point-of-sale system, a request to redeem an economic incentive received from a portable electronic device in accordance with an illustrative embodiment of the invention;

FIGS. 13A-13F show various configurations into which a portable electronic device can be folded and unfolded in accordance with an illustrative embodiment of the invention;

FIG. 14 is an illustration of a locking hinge that includes a grooved hinge pin in accordance with an illustrative embodiment of the invention;

FIG. 15 is an illustration of a locking hinge that includes a tongue-and-groove locking mechanism in accordance with another illustrative embodiment of the invention;

FIGS. 16A-16E show various configurations into which a portable electronic device can be folded and unfolded in accordance with another illustrative embodiment of the invention;

FIGS. 17A and 17B are illustrations of a hinging mechanism that includes an elastic band in accordance with an illustrative embodiment of the invention;

FIG. 18 is a front view of a portable electronic device showing a set of input controls for controlling the operation of the device in accordance with another illustrative embodiment of the invention;

FIG. 19 is a flowchart of a method for displaying content on a portable electronic device in accordance with an illustrative embodiment of the invention; and

FIG. 20 is a flowchart of a method for redeeming an economic incentive in accordance with an illustrative embodiment of the invention.

### DETAILED DESCRIPTION

In an illustrative embodiment of the invention, a user can view content on a portable electronic device while using the device in a variety of venues such as while seated at a large table, while seated at a smaller table, while standing on a bus or train, or while walking. Herein, “portable electronic device” is used to refer to any portable electronic apparatus that is capable of displaying content. Examples of “content” include, without limitation, text, photographs, graphics, and video. Such content may be displayed, for example, in the context of an electronic newspaper, electronic magazine, electronic book (eBook), electronic document, Web site, movie, or TV show, depending on the particular end-user application. A device configured for viewing content such as electronic newspapers and eBooks is sometimes referred to in the industry as an “electronic reader.”

In addition, in at least one configuration, the user of the device can store the device in a pocket or small container, and the user can control the content and formatting of the content that is displayed on the device. Further, a content provider for the device can customize the content for different user profiles.

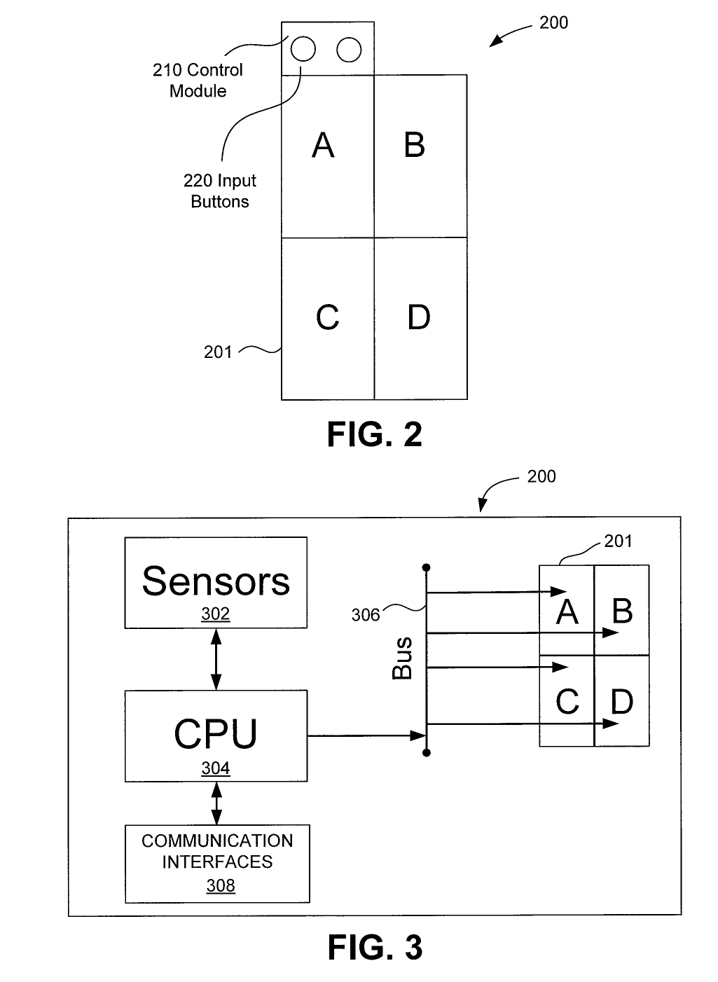

In one aspect, an apparatus and method for displaying content on a portable electronic device is provided. FIG. 2 is an illustration of a portable electronic device 200 that includes a control module 210 with input buttons by which a user can control the portable electronic device in accordance with an illustrative embodiment of the invention. In this illustrative embodiment, the portable electronic device includes a composite display 201 with multiple independent display panels (labeled “A,” “B” “C,” and “D” in FIG. 2) that are connected mechanically by one or more hinging mechanisms (not shown in FIG. 2). In this embodiment, portable electronic device 200 includes a control module 210 with one or more input buttons 220 for controlling the operation of portable electronic device 200. In other embodiments, input controls other than buttons are employed. For example, in some embodiments, the portable electronic device includes a touch-screen user interface instead of or in addition to buttons or other types of control elements.

The various separate display panels are also connected electrically. FIG. 3 is a high-level block diagram of the portable electronic device 200 shown in FIG. 2 in accordance with an illustrative embodiment of the invention. In FIG. 3, the individual display panels of composite display 201 are connected with a central processing unit (CPU) 304 via bus 306. CPU 304 is, in turn connected with one or more sensors 302. The role of sensors 302 is discussed below. In one embodiment, the separate display panels of composite display 201 are connected with bus 306 by flexible ribbon connectors. In another embodiment, they are connected by short-range wireless links in accordance with a standard such as BLUETOOTH. Portable electronic device 200 also includes one or more communication interfaces 308.

The composite display 201 can be folded and unfolded into a variety of different configurations—e.g., vertically and horizontally—to provide the user a variety of options in how to view content displayed on the device. For example, in the various configurations, the effective display size can be different to accommodate different content-viewing environments.

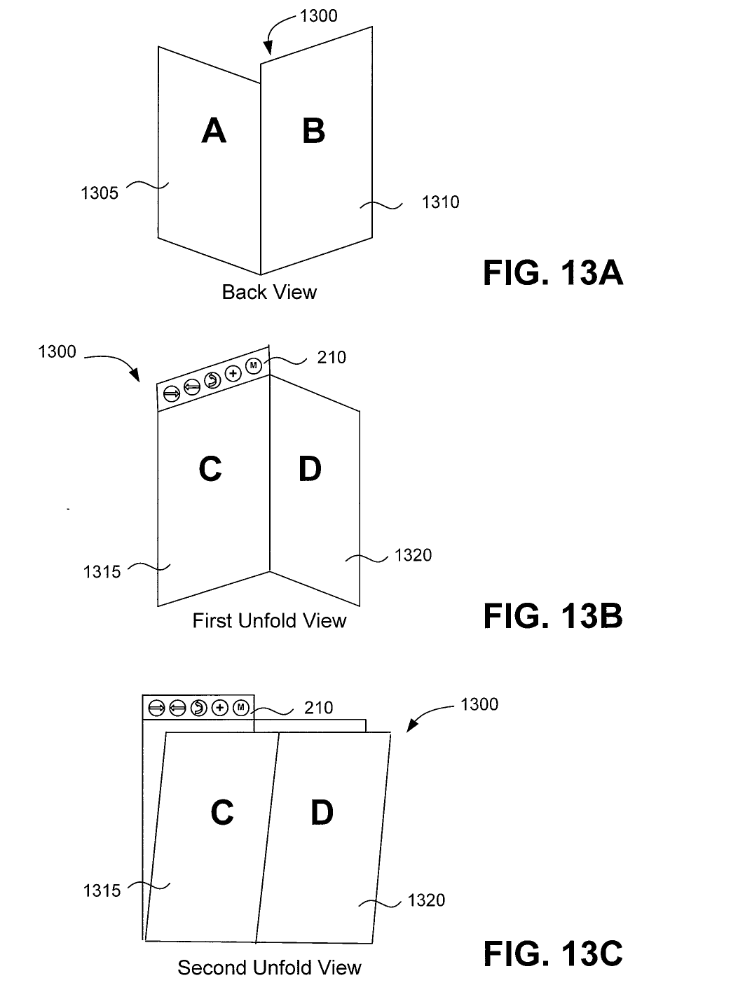

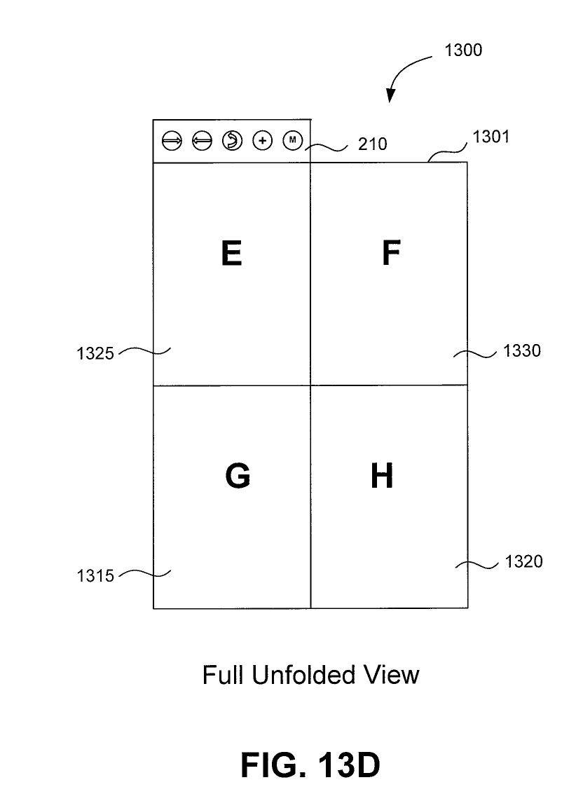

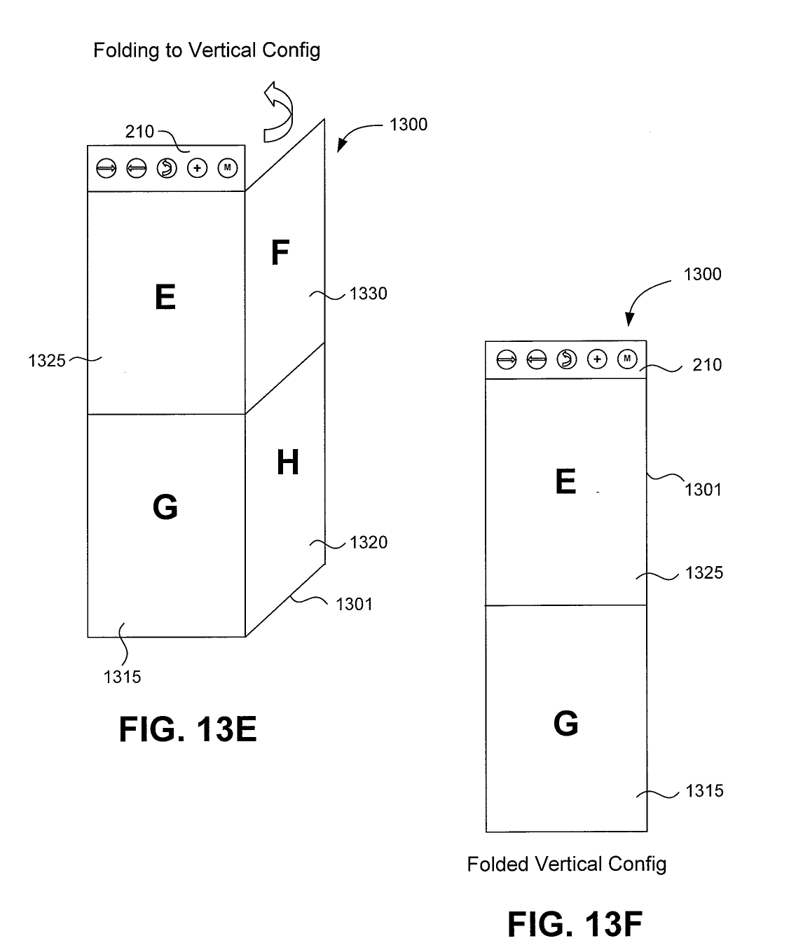

In a second aspect, an apparatus and method by which the display screens are protected when the portable electronic device is in its folded position is provided. In one embodiment, the device has a tough plastic outer shell (see FIG. 13A) that covers the plastic screen when the device is in its closed position.

In a third aspect, an apparatus and method by which the device can be opened into its various configurations in an intuitively straightforward and fool-proof manner is provided. In one embodiment, a portable electronic device with four display panels includes two extra display surfaces (i.e., two of the four display panels include a display surface on both their front and back surfaces) to avoid the need to unfold the device along two axes to start reading content on the portable electronic device and also to eliminate the need to fold the horizontal hinge backward on itself. In general, a display panel may have a display surface on its front surface, back surface, or both, depending on the particular embodiment.

In a fourth aspect, an apparatus and method whereby the portable electronic device can easily be held in one hand when the display panels are unfolded into a particular configuration is provided. In one embodiment, the hinges between the panels may be made with a locking mechanism to hold the panels firmly in an open or closed mode. Additionally, in some embodiments, the device includes an adjustable locking mechanism to keep the display panels securely in a desired configuration.

In a fifth aspect, an apparatus and method is provided by which the device displays content only on those display panels which are visible to a user when one or more display panels are folded behind the front panel(s). In one embodiment, the portable electronic device includes sensors 302 (see FIG. 3) distributed as needed throughout the various display panels to enable the device to detect the current configuration of the composite display (i.e., in which of the various configurations the display panels are currently arranged). In one embodiment, capacitively coupled sensors are used to detect the current display configuration.

A processing unit (CPU) then determines, based on the detected current configuration, which display panels are visible to the user and which are hidden. In one embodiment, the device presents content only on the visible display panels, the hidden display panels being left blank. In another embodiment, advertising or other content intended for the consumption of nearby persons other than the user of the portable electronic device is displayed on the hidden panels.

In a sixth aspect, an apparatus and method is provided by which the reader can continue reading information that would be displayed on the hidden display panels if the portable electronic device were in its fully unfolded “broadsheet” configuration without the user having to turn the portable electronic device over or, for example, rearrange the hinged display panels of the portable electronic device. (Note: “Broadsheet” is a newspaper-industry term referring to the largest of various newspaper formats.) In some embodiments, the device is equipped with input controls such as buttons or a touch-screen user interface by which the user can indicate the content he or she wishes to view. When the user issues such an input, the device's CPU senses which display panels are hidden and which display panels are visible and replaces the information on the visible panels with the information that would be displayed on the hidden panels if the portable electronic device were in its fully unfolded broadsheet configuration.

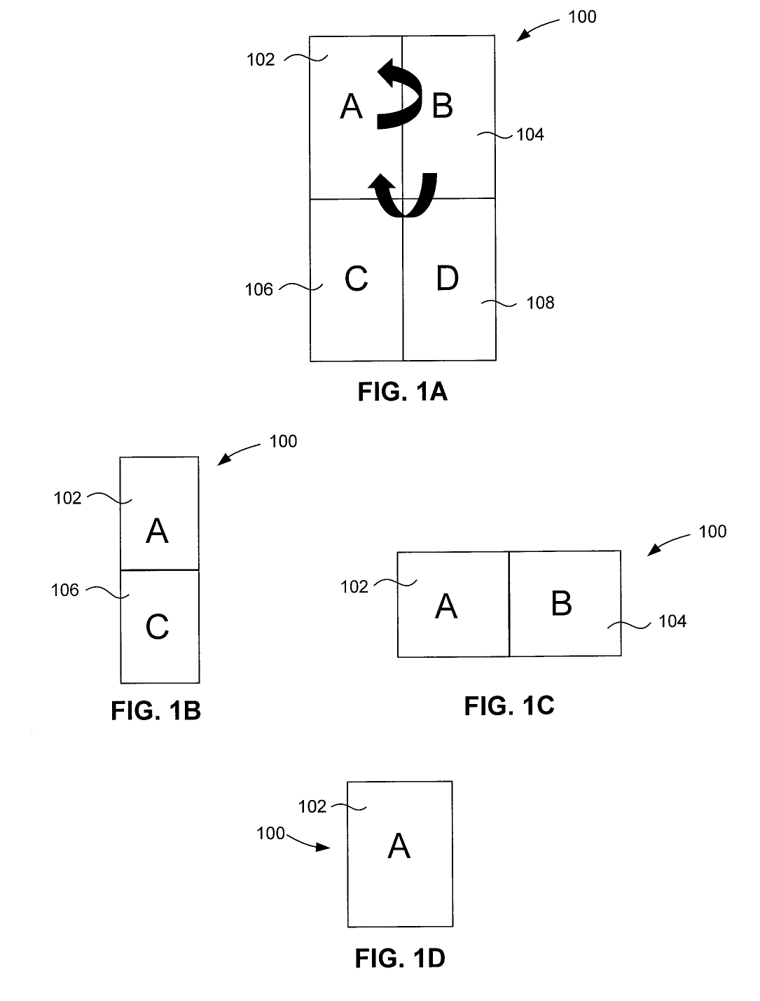

FIGS. 1A-1D are simplified illustrations of a four-panel, four-square (two-by-two) composite display 100 for a portable electronic device in accordance with an illustrative embodiment of the invention. FIG. 1A shows composite display 100 when it is fully unfolded into its broadsheet configuration. Composite display 100 includes separate, flexibly-hinged display panels 102, 104, 106, and 108. As indicated in FIG. 1A, composite display 100 can be folded along its horizontal and vertical seams. This allows composite display 100 to be folded into a plurality of other configurations.

FIG. 1B shows composite display 100 after a user has folded it in a vertical manner so that only the two left-hand display panels 102 and 106 (labeled “A” and “C,” respectively) are visible. In one embodiment, the device's CPU, in this particular configuration, automatically leaves blank right-side display panels 104 and 108. When the user desires to read the content that would normally appear on the two right-hand display panels 104 and 108 when composite display 100 is in its fully-unfolded, broadsheet configuration, he or she inputs a command to the device to replace the information displayed on the two left-hand panels 102 and 106 with that right-side content. In this embodiment, if the user repeats the command, the content displayed on display panels 102 and 106 becomes the left-side content of the next page or portion of the current content item, and so forth.

If the user at any time unfolds composite display 100 into the broadsheet configuration, the CPU senses this configuration and replaces the information on the left-hand display panels 102 and 106 with content from the left-hand side of the currently displayed page and fills the right-hand display panels 104 and 108 with content that would normally be displayed on the right-hand display panels 104 and 108 if composite display 100 were in its fully unfolded configuration.

FIG. 1C illustrates composite display 100 after the user has folded composite display 100 so that only the two top display panels 102 and 104 (labeled “A” and “B,” respectively) are visible. In one embodiment, the CPU senses this configuration and displays content on the top two display panels 102 and 104. When the user enters a predetermined input, the device replaces information on the top two panels 102 and 104 with content that would otherwise appear on the bottom two display panels 106 and 108 if composite display 100 were fully unfolded. For each subsequent input command from the user, the CPU advances the composite display 100 through the content in a top-then-bottom fashion for the current page or portion of content, followed by the top of the subsequent page or portion of content, and so forth.

FIG. 1D illustrates composite display 100 after a user has folded composite display 100 so that only the upper left hand panel 102 (labeled “A”) is visible. That is, composite display 100 has been folded to the height and width dimensions of a single display panel (102). This configuration is advantageous, e.g., for viewing content in a crowded environment such as a bus or train or for stowing the device in a pocket or container. In one embodiment, the CPU senses this configuration automatically and sequentially advances the content displayed on that upper-left panel 102 through the four quadrants of the content page or portion and then through the corresponding quadrants of a subsequent page or portion of the content item, and so forth.

In general, a portable electronic device in accordance with an illustrative embodiment of the invention may be configured to detect the current configuration of composite display 100 and to display content in accordance with that detected present configuration. Further, when the composite display is changed to a different configuration, the portable electronic device can be configured to respond automatically by displaying content in accordance with the new configuration. The configurations and device behavior discussed above in connection with FIGS. 1A-1D are merely examples of how this is done in a particular embodiment. In other embodiments, the portable electronic device may include a different number of display panels (e.g., two or more than four) and may be configured to fold and unfold in a manner different from the above examples.

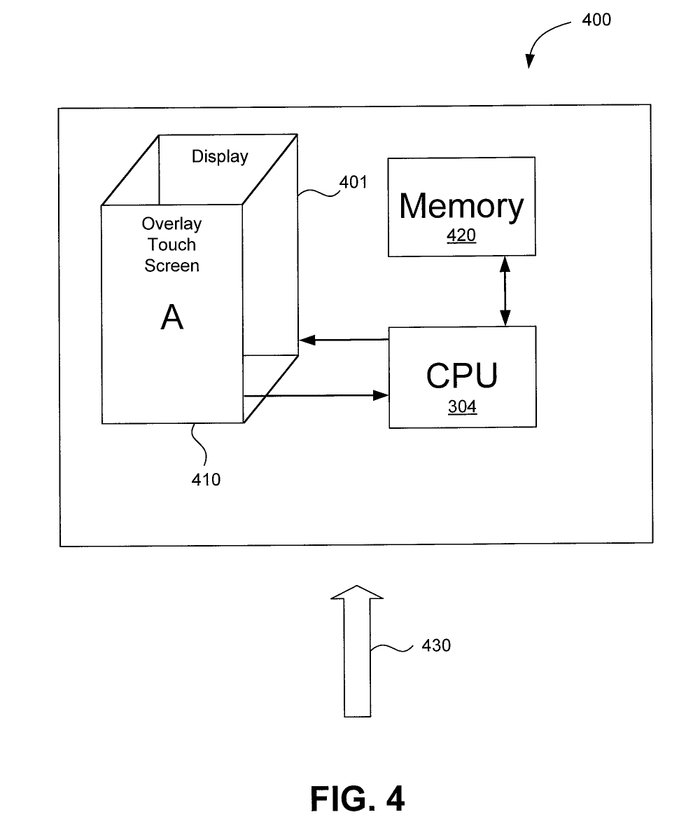

In a seventh aspect, an apparatus and method is provided by which a user is able to continue an article or other content item that does not end on the page or portion being viewed. In an embodiment in which the portable electronic device is used to view newspaper articles, there are likely to be articles that are continued from one page to another in the newspaper's layout. FIG. 4 is a high-level block diagram of a portable electronic device 400 that includes a touch-sensitive composite display in accordance with another illustrative embodiment of the invention. (Note that, in FIG. 4, the separate display panels of composite display 401 are not shown for simplicity.) In FIG. 4, at least one display panel of composite display 401 is covered with a touch-sensitive plastic screen (“touch screen”) 410 containing a grid of electric circuits that can sense the approximate location where the user touches touch screen 410 to make an input. Optionally, the user may use a stylus 430 in contacting touch screen 410. In some embodiments, the content displayed on portable electronic device 400 includes Hypertext-Markup-Language (HTML) tags that link to other content (e.g., a subsequent page of an article).

Touch screen 410 is electrically connected to CPU 304, which can compute the location where the user has touched touch screen 410 to enter an input. In the context of a newspaper article, when the user contacts touch screen 410 by touching the bottom of the column that contains the article, CPU 304 calculates what location on composite display 401 is being “touched.” CPU 304 then, in sequence, (i) references the HTML tag to determine the page of content where the article is continued, (ii) removes the content displayed on composite display 401; (iii) obtains the content for the continuation page from memory 420, and (iv) displays at least a portion of the continuation page.

As an example, composite display 401 may display page 1 of a newspaper's content, which happens to contain an article in column 3 that continues-on page 16. The bottom of column 3 may display “continued on page 16.” The user touches the place on touch screen 410 where the hyperlinked words “continued on page 16” appear, causing the displayed content to jump to page 16 from page 1. When the reader wishes to return to the content of page 1, he or she touches the hyperlinked words “continued from page 1” at the top of the continued portion on page 16.

Though FIG. 4 shows an implementation in which touch screen 410 is an overlay of the display panels of composite display 401, in other embodiments touch screen 410 is implemented behind (beneath) the display panels of composite display 401. In general, composite display 401 of portable electronic device 400 may include one or more touch-sensitive display panels, and the program instructions residing in memory 420 and executed by CPU 304 may include support for a touch-responsive user interface.

In an eighth aspect, an apparatus and method is provided by which a user can temporarily enlarge content viewed on the portable electronic device. In one embodiment, the content of an article is associated by the CPU 304 with a location on the touch screen 410. When the user inputs a predetermined command and then, within a defined period of time, touches the article in question, the display of that article is enlarged so that a nearsighted user can read the article in question without glasses. Should the user wish to observe the entire page of content, he or she may tap the touch screen 410 again, and the content returns to the full-page display.

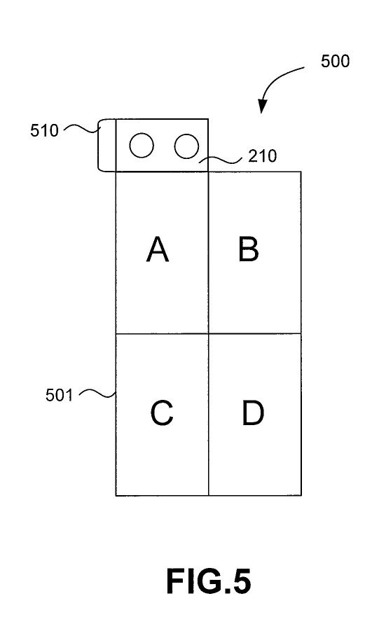

FIG. 5 is an illustration of a portable electronic device 500 that includes a rocker switch 510 by which a user can reposition content displayed on composite display 501 in accordance with an illustrative embodiment of the invention. To move up and down through an enlarged article, the user, in this embodiment, pushes rocker device 510 up or down.

In other embodiments, the user may enlarge content on the composite display by simply actuating a “zoom” control among the input controls of the portable electronic device. In some embodiments, a single zoom control is capable is issuing two distinct inputs to CPU 304, one to enlarge the content (“zoom in”) and one to reduce the content (“zoom out”). For example, the zoom control may be implemented as a multi-position rocking switch.

In a ninth aspect, an apparatus and method for providing user-tailored advertising or other content is provided. In this aspect, a server contains a database of the user's address, zip code, or demographic information. Based on this information, customized advertising or other customized content is supplied to the portable electronic device by the server over a network such as the Internet.

In a tenth aspect, an apparatus and method for providing coupons or other economic incentives to users of the portable electronic device is provided. In one embodiment, coupons are displayed on the device as they would be in a regular newspaper or other publication. In one embodiment, portable electronic device 400 is equipped with a touch screen 410, a CPU 304, and a short-range radio link such as a Wi-Fi or BLUETOOTH transceiver.

When the user taps on the coupon on the touch screen 410, CPU 304 determines the coupon being selected by comparing the location of the touch-screen input and the coupon being displayed. CPU 304 then retrieves the coupon content from memory 420, converts it to a printable format such as PDF, and transmits the coupon to a designated printer 715 on the local area network 730 (see FIG. 7). Alternately, the CPU 304 stores the coupon to the memory 420 for printing out when the portable electronic device is on a local area network 730 with a printer 715. In yet another alternative, the CPU 304 transmits the coupon and the user's identification number to the store's computer system where it is stored. When the user presents his or her identification number at checkout on a subsequent visit to the merchant's store, the store's point-of-sale system retrieves the coupon and automatically adjusts the purchase price accordingly. Such a system for redeeming economic incentives can be implemented with both physical (“brick-and-mortar”) stores and on-line stores.

In general, a portable electronic device in accordance with various illustrative embodiments of the invention displays content on a composite display that can be configured (folded and unfolded) in a variety of ways to accommodate different viewing situations and user preferences. In the context of electronic newspapers, for example, such a device can be used to simulate the experience of folding a newspaper page in various ways to facilitate reading. The user may also change the manner in which the content is displayed to facilitate viewing the content.

### I. A Composite Display

In one illustrative embodiment, size A5 electrophoretic displays implemented on flexible plastic substrate are used. Six display screens are sited on four separate display panels arranged in a four-square (two-by-two) configuration, as shown in FIG. 1A. The separate display panels (102, 104, 106, and 108) are mechanically joined by a set of flexible hinging mechanisms along the interior x and y axes (seams) to form a composite display. Two of the four flexible panels are backed with a thin plastic material which provides rigidity and durability to the display panels and allows for electric wiring to be routed between the display and the backing plates.

In this particular embodiment, the remaining two panels have display surfaces on both their front and back surfaces. Each panel may be less than 0.07″ in thickness. The four panels can be folded together with the plastic backing on the outside, or, for vertical reading, can be pivoted 180 degrees so that the display side is on the outside. As shown in FIGS. 1A-1D, the four display panels can be folded into at least four distinct configurations for viewing by a user: full broadsheet (FIG. 1A); vertical with two panels visible (FIG. 1B); horizontal with two panels visible (FIG. 1C); and one-panel-sized (FIG. 1D).

Mounted to the backing plate and on the top edge of the upper left display panel 102, in this particular embodiment, is a control module 210 (see FIG. 2) which may contain (i) a battery power supply; (ii) flash memory to store program instructions such as an operating system and software applications; (iii) a CPU 304 to control the operation of the electronic reader and (iv) one or more communication interfaces 308 (e.g., a wireless transceiver) for the receipt of content into the device and the transmission of data to other devices. Control module 210 may also include buttons or other control elements for user input and a plug-in port for recharging or connecting the reader to a PC. For example, control module 210 may include a Universal Serial Bus (USB) port. Further, control module 210, in some embodiments, includes an Ethernet connector for connecting the portable electronic device to a local-area network (LAN), which may, in turn, be connected with the Internet.

In general, the portable electronic device may include a variety of different communication interfaces 308 such as, without limitation, a wireless personal area network (PAN) transceiver, a wireless local area network (WLAN) transceiver, a broadcast radio receiver (e.g., an FM receiver), an Ethernet port, and a USB port. The portable electronic device, in some situations, may transmit data over a network to a server. Such a transmission may be, for example, for the purpose of authenticating the portable electronic device with the server, requesting content to be downloaded to the device from the server, or for some other purpose, depending on the application.

In this embodiment, control module 210 connects to the adjacent display panel via edge-mount connectors and to the other three display panels via ribbon connectors which are mounted behind the display surface of the adjacent display panel and in front of the backing plate of the adjacent display panel. The ribbon connectors are then routed through the hinges to provide electrical connectivity to all six display surfaces. As mentioned above, in other embodiments, the display panels are connected with bus 306 via short-range wireless links. Such short-range wireless links may, for example, be based on PAN technology such as the BLUETOOTH standard.

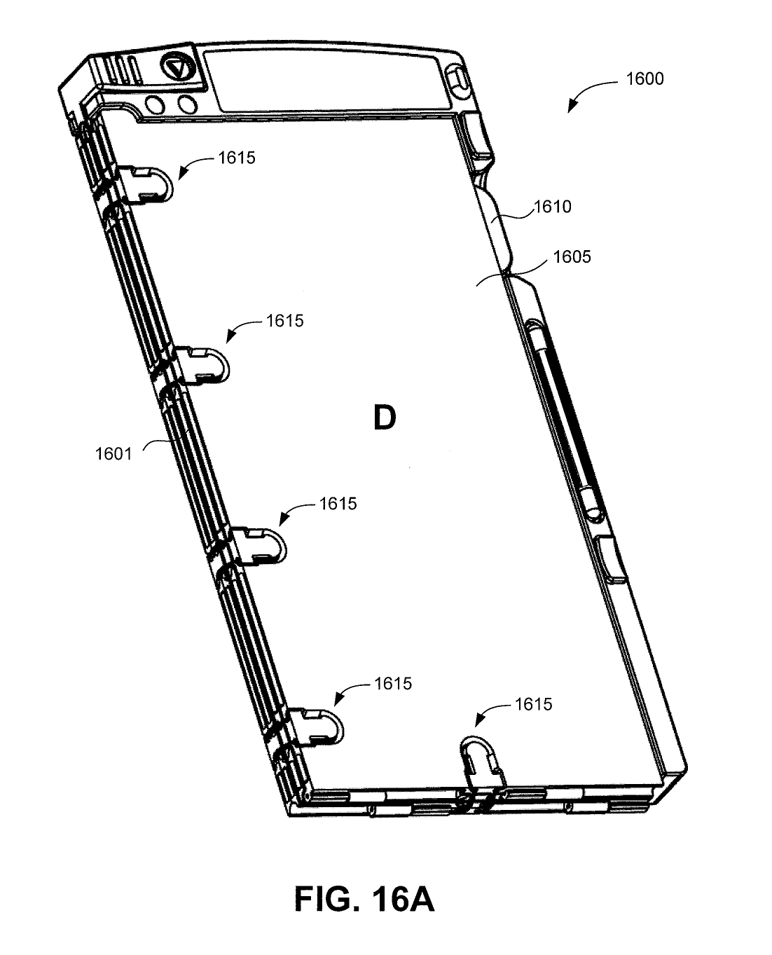

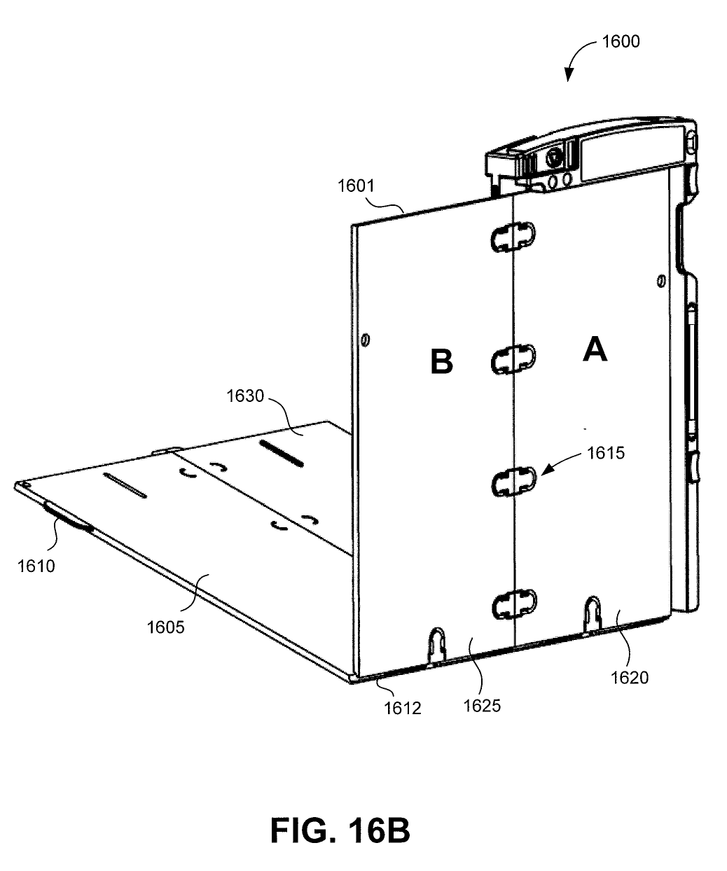

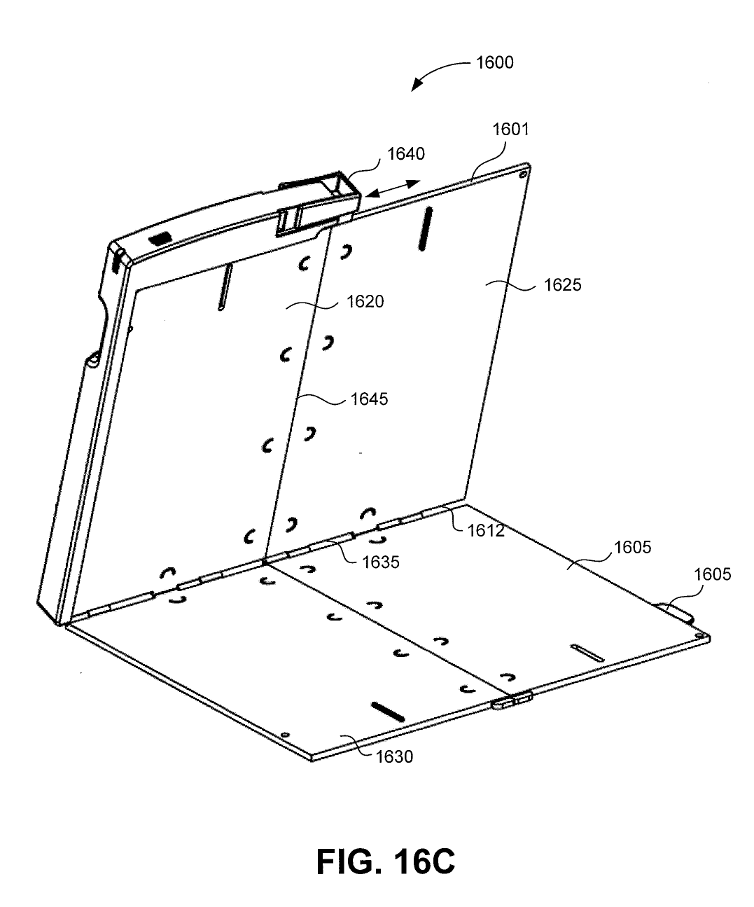

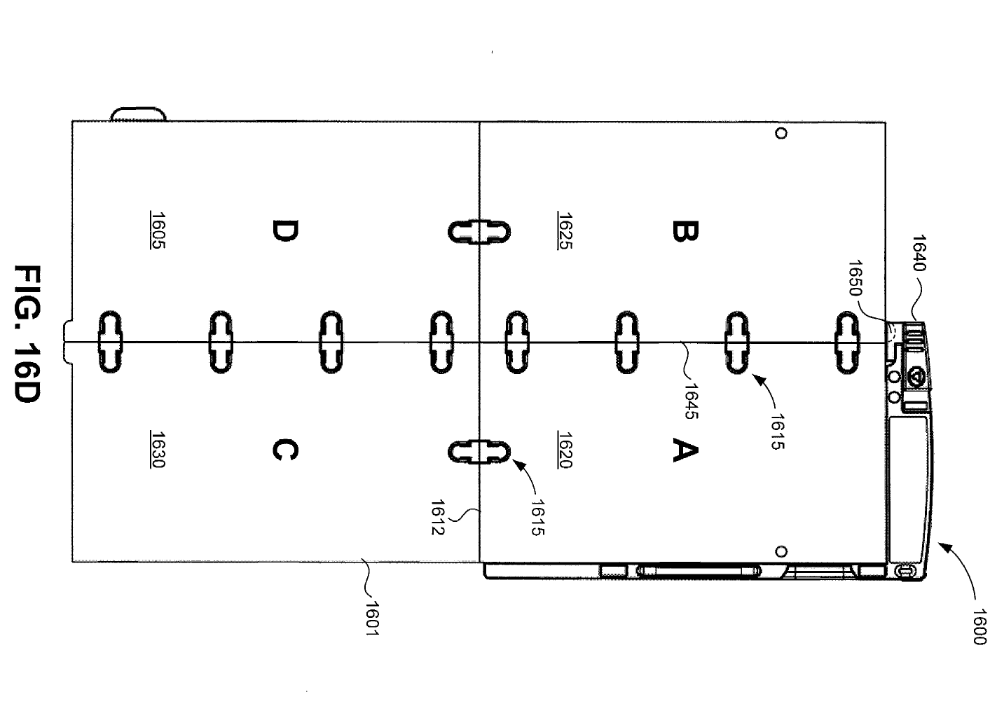

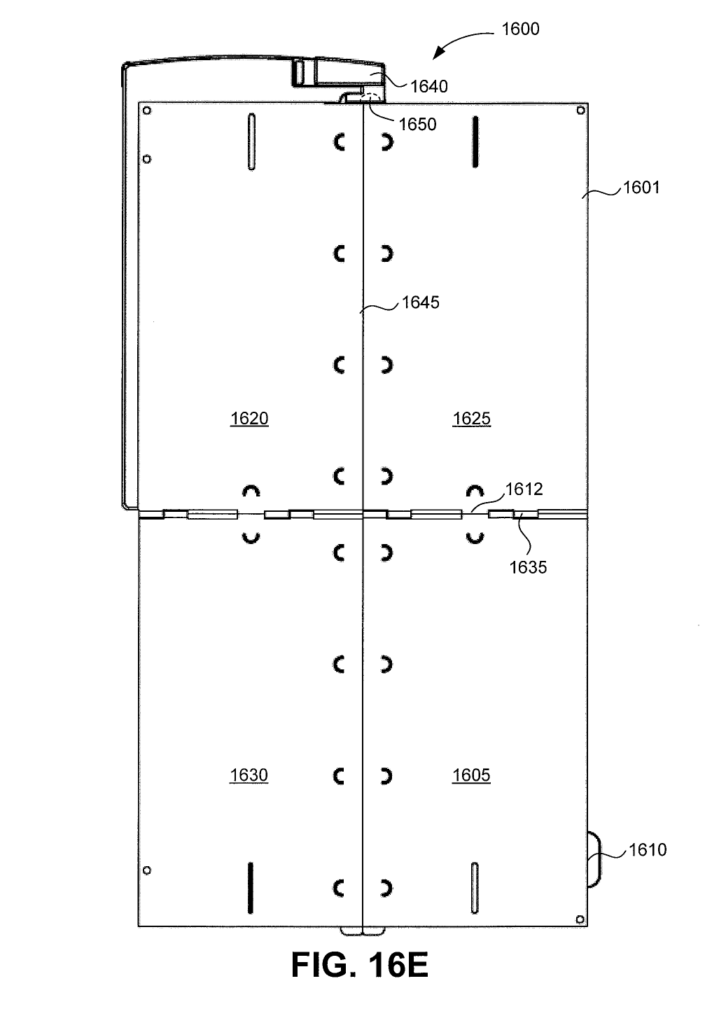

FIGS. 16A-16E show various configurations into which a portable electronic device can be folded and unfolded in accordance with another illustrative embodiment of the invention. FIG. 16A is a perspective view of a portable electronic device 1600 in accordance with this embodiment. Portable electronic device 1600 includes a composite display 1601 made up of four separate display panels, one of which (1605) is visible in FIG. 16A. Note that, in FIGS. 16A-16E, the actual display surfaces on the display panels have been removed to more clearly show the details of the hinging mechanisms. In place of those display surfaces, letters (A-D) are shown in these figures. In one embodiment, each display panel has a display screen on only its front surface, resulting in a total of four display screens instead of the six employed in the embodiment described above in connection with FIGS. 1A-1D.

The display panels of composite display 1601 are joined by a set of elastic hinges 1615 or other suitable hinging mechanisms that allow adjacent display panels to be folded around each other but also, when the device is in its open, unfolded position, cause adjacent display panels to pull tightly together so that the composite display surface appears to be a single display surface. Tab 1610 on the side of one of the display panels allows the composite display 1601 to be unfolded more easily.

FIG. 16B is a perspective view of portable electronic device 1600 after it has first been unfolded to a two-panel horizontal configuration in which display surfaces “A” and “B,” respectively, of display panels 1620 and 1625 are exposed and after it subsequently has been partially unfolded along its horizontal seam 1612.

FIG. 16C is a perspective view of a configuration similar to that shown in FIG. 16B but from the back side of portable electronic device 1600. As shown in FIG. 16C, composite display 1601 may include a hinge 1635 of the pin-and-cylinder type with locking grooves along its horizontal seam 1612 and elastic hinges 1615 along its vertical seam 1645. In other embodiments, the positions of the two types of hinges may be reversed, or all of the hinges may be of the same type, whatever that happens to be in the applicable embodiment. As shown in FIG. 16C, portable electronic device 1600 may also include a sliding locking mechanism 1640. The function of locking mechanism 1640 is explained below.

FIG. 16D is a front view of portable electronic device 1600 when it is fully unfolded into a broadsheet configuration. In this configuration, all four display panels 1605, 1620, 1625, and 1630 are substantially in the same plane to form a combined large-format display. When locking mechanism 1640 is slid to the left in this embodiment, a slot within locking mechanism 1640 (not shown in FIG. 16D) straddles tab 1650 on the top right corner of display panel 1625 to prevent display panels 1625 and 1605 from folding backward along vertical seam 1645. In this way, the user can securely hold portable electronic device 1600 with one hand while multi-panel display 1601 is fully unfolded. FIG. 16E shows a back view of portable electronic device 1600 when composite display 1601 is in its fully unfolded configuration.

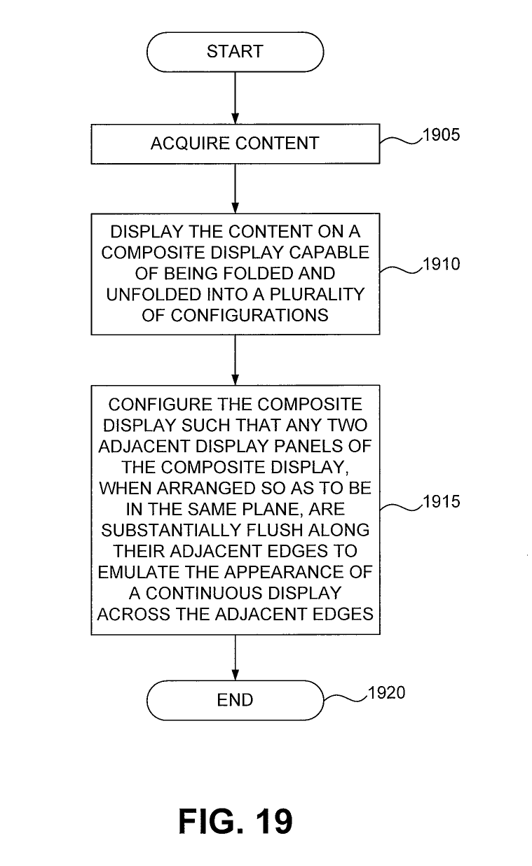

FIG. 19 is a flowchart of a method for displaying content on a portable electronic device in accordance with an illustrative embodiment of the invention. At 1905, the portable electronic device acquires content to be displayed. For example, the portable electronic device may download content from a server over a network. At 1910, the content is displayed on a composite display that includes a plurality of separate display panels. The composite display is capable of being folded and unfolded into a plurality of different configurations. At 1915, the composite display is configured such that any two adjacent display panels, when arranged so as to be in the same plane, are substantially flush along their adjacent edges to emulate the appearance of a continuous display across the adjacent edges. At 1920, the process terminates.

A variety of different display technologies may be used in implementing a foldable composite display in accordance with various embodiments of the invention. For example, the portable electronic device may include a bi-stable or “zero-power” display in some embodiments. Some examples of suitable display technologies include, without limitation, electrophoretic display technology, cholesteric liquid crystal display (ChLCD) technology, organic light-emitting diode (OLED) display technology, and electrowetting display technology. In general, any display technology that is low in power consumption, that can be implemented in a thin display panel, and that can be refreshed quickly enough to support the intended content types can be used in implementing the foldable composite display.

### II. Protection of Display Surfaces When Device is Folded

FIGS. 13A-13F show various configurations into which a composite display of a portable electronic device can be folded and unfolded in accordance with an illustrative embodiment of the invention. FIGS. 13A-13F depict an embodiment in which (i) two of the four display panels (1325 and 1330) have a plastic backing 1305 and 1310, (ii) the other two panels (1315 and 1320) have displays on both their front and back sides, (iii) the horizontal hinge (not shown in FIGS. 13A-13F) will bend in only one direction, and (iv) the vertical hinge (not shown in FIGS. 13A-13F) will bend in two directions when the device is in the fully unfolded (broadsheet) mode but not otherwise. This hinge structure ensures that portable electronic device 1300 can only be folded or unfolded in one sequence. Furthermore, the two-sided display panels 1315 and 1320 (marked “G” and “H” on their front sides, “C” and “D” on their back sides) mean that the easiest way to store and open portable electronic device 1300 is from a “clam-shell” configuration in which the plastic backing panels 1305 and 1310 protect the composite display against unintentional damage.

In the above illustrative embodiment, the somewhat flexible plastic displays are stiffened in the case of two of the four display panels (1325 and 1330) by the use of rugged plastic backing panels and in the case of the other two panels (1315 and 1320) by the use of back-to-back displays (e.g., electrophoretic displays).

### III. Hinging Mechanisms to Support Multiple Display Configurations

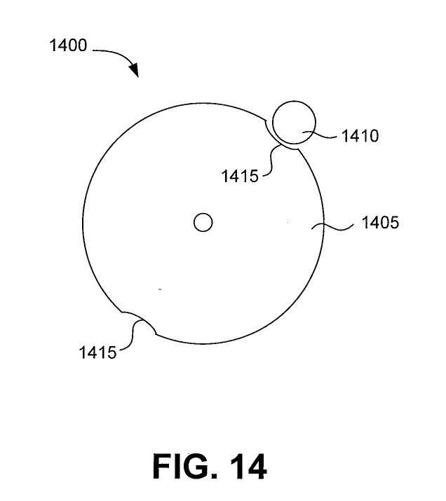

FIG. 14 is an illustration of a locking hinge 1400 that includes a grooved hinge pin 1405 in accordance with an illustrative embodiment of the invention. In the illustrative embodiment discussed above, portable electronic device 1300 is equipped with self-centering hinges that include small indent grooves 1415 on the hinge pin 1405 and a spring-loaded locking rider 1410 that drops into these grooves when the display panels are aligned in the desired locations.

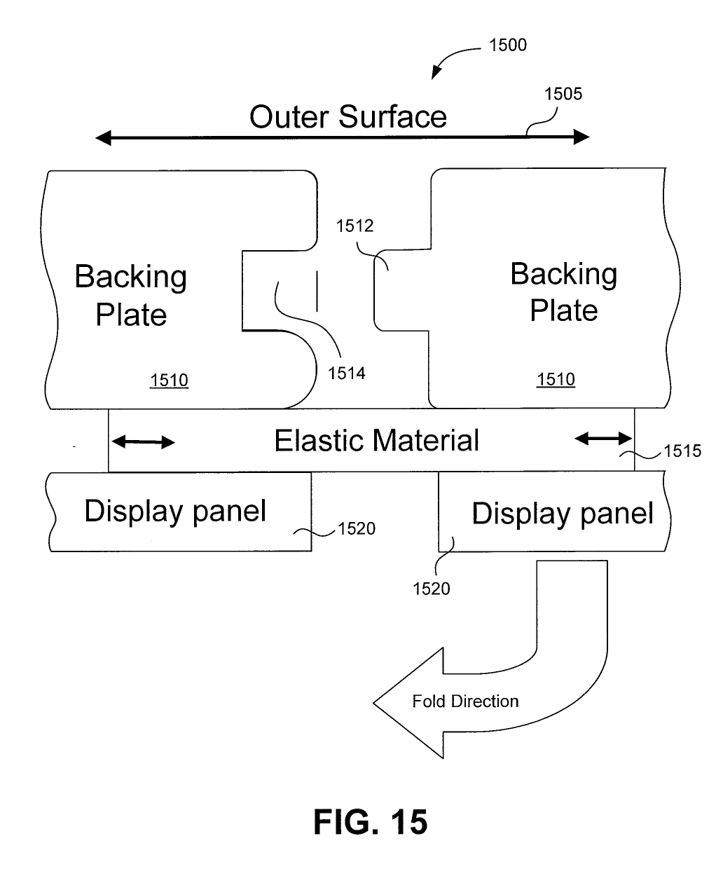

In some embodiments, the backing plates 1305 and 1310 have tongue-and-groove edges that engage when two adjacent panels are aligned in the desired locations, as illustrated in the edgewise view of FIG. 15. FIG. 15 shows an outer surface 1505 of backing plates 1510 associated with two adjacent display panels 1520. One backing plate 1510 includes a tongue 1512; the other backing plate 1510 includes a mating groove 1514. A sheet of elastic material 1515 (e.g., a MYLAR film) disposed between backing plates 1510 and display panels 1520 pulls the backing plates 1510 and their associated display panels together so that they are substantially flush along their adjacent edges when they are arranged so as to be in the same plane to form a composite display. This promotes the appearance of a continuous, uninterrupted display across the adjacent edges (seam) of the adjacent display panels 1520. When the adjacent display panels 1520 are arranged in this fashion, tongue 1512 and groove 1514 engage to provide further stability. The sheet of elastic material 1515 stretches to permit the display panels 1520 to be pivoted to other configurations.

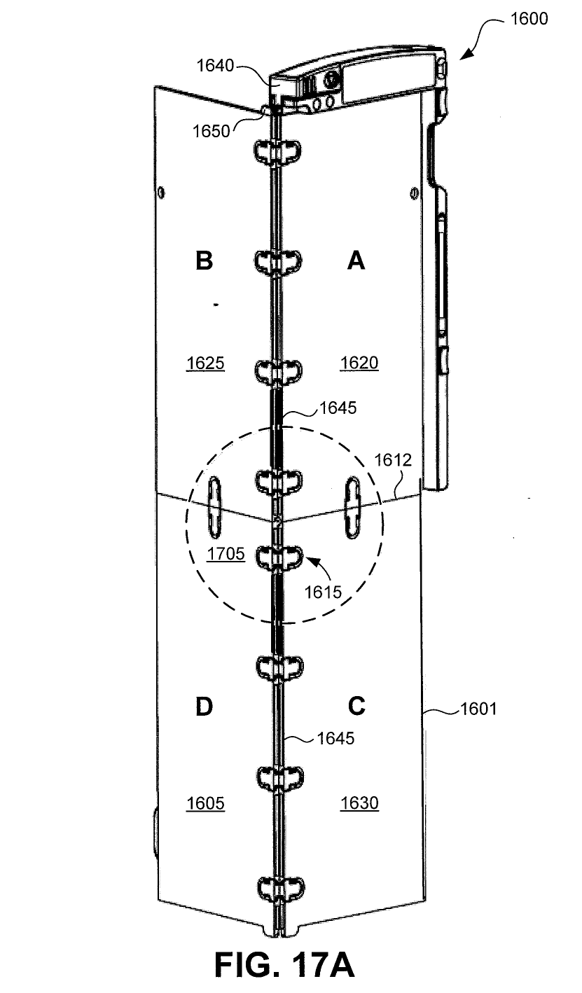

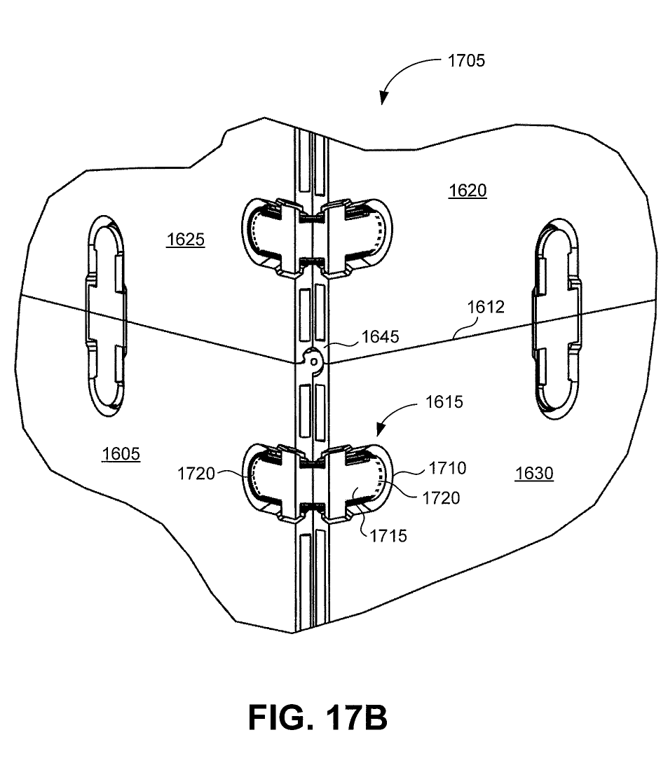

FIG. 17A is a perspective view of a portable electronic device 1600 (see FIGS. 16A-16E for other illustrations related to this embodiment) in accordance with an illustrative embodiment of the invention. In this example, locking mechanism 1640 has been slid back to the right to allow display panels 1625 and 1605 to fold backward along vertical seam 1645 of composite display 1601. In this embodiment, display panels 1625 and 1605 can be folded through 180 degrees so that the back surfaces of those display panels are in contact with the corresponding (back) surfaces of display panels 1620 and 1630, respectively. This configuration is thus the mirror image of that shown in FIG. 1B.

Section 1705 (within the dashed circle) in FIG. 17A includes several elastic hinges 1615. FIG. 17B is a blown-up view of section 1705 indicated in FIG. 17A. Though only one elastic hinge 1615 has been annotated with reference numerals in FIG. 17B for simplicity, the following description applies to the other elastic hinges 1615. In this embodiment, elastic hinge 1615 includes a slot 1710 in each of the adjacent display panels (1605 and 1630). Each slot 1710 extends from the adjacent edge of that display panel along either the front or back surface of that display panel, depending on the embodiment. Within each slot 1710 is a stop or “tongue” 1715. In some embodiments, this stop is integrally molded with the display panel. An elastic band 1720 is seated within each of the two aligned slots 1710 and is looped around the stops 1715 of both adjacent display panels 1605 and 1630. In one embodiment, elastic bands of the sort used in orthodontics are employed. Additionally, the adjacent edges of the adjacent display panels 1605 and 1630 may include a tongue-and-groove arrangement, as described above. In some embodiments, the elastic hinges 1615 are partially hidden behind the actual display screens of the display panels, leaving only the portion along the hinged edges exposed to view.

Elastic hinge 1615 pulls the adjacent display panels 1605 and 1630 snugly together along their adjacent edges when those display panels are arranged so as to be in the same plane. That is, elastic hinges 1615 cause any two adjacent display panels of portable electronic device 1600 to be substantially flush along their adjacent edges when the adjacent display panels are arranged so as to be in the same plane, thereby emulating the appearance of an uninterrupted display across the adjacent edges. Elastic hinge 1615 also allows the joined adjacent display panels to be pivoted into other configurations in which those display panels are not in the same plane.

### IV. Selective Population with Content of the Display Panels

In the embodiment described above in connection with FIGS. 13A-13F, each of the three display panels which are not adjacent to control module 210 (1315, 1320, and 1330) has a small proximity sensor 302 (see FIG. 3) mounted on the rear side of that display panel so that a predetermined electromagnetic change occurs when a display panel is folded away from the front side of portable electronic device 1300 or is folded toward and brought into contact with or close proximity to another display panel. In one embodiment, the sensors 302 are of the capacitively-coupled type. In other embodiments, magnetic sensors, electrical-contact (impedance) sensors, or any other suitable type of sensors 302 may be employed to detect the particular configuration in which the composite display 1301 of portable electronic device 1300 is arranged at any given time.

For simplicity in this Detailed Description, the condition in which, in a particular configuration of composite display 1301, a sensor 302 of a first display panel is in close proximity to or in direct contact with the corresponding sensor 302 of a second display panel (e.g., the two display panels are folded so as to be in contact along their front or back sides) will be referred to herein as the sensor 302 being “closed.” Likewise, the condition in which the display panels are arranged so that their respective sensors 302 are not in close proximity (e.g., the display panels are fully unfolded in the broadsheet configuration) is referred to herein as the sensor 302 being “open.”

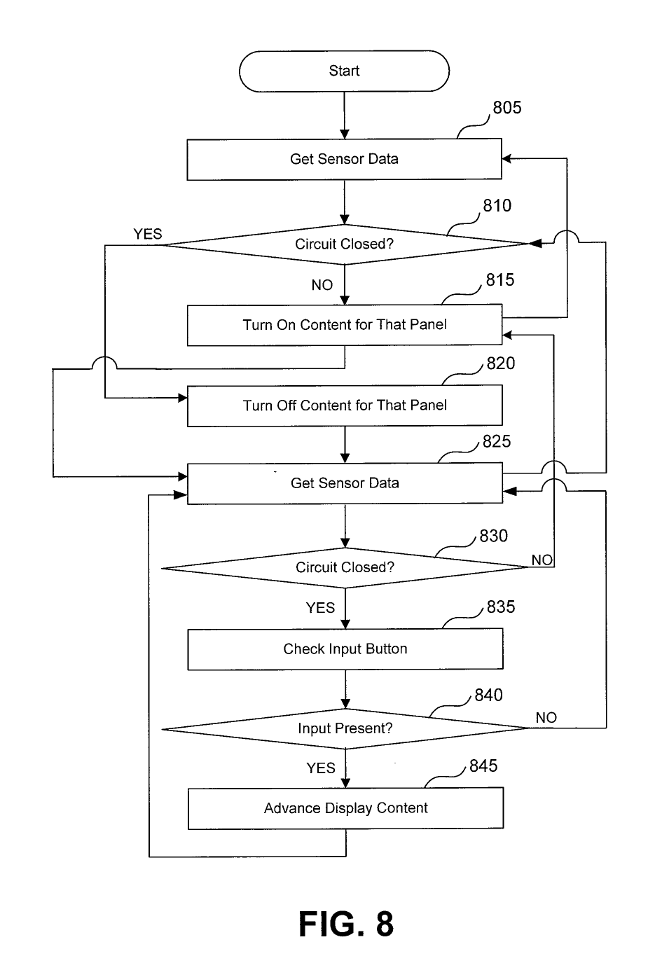

FIG. 8 is a flowchart of a method for displaying and advancing content on a portable electronic device in accordance with an illustrative embodiment of the invention. The flowchart shown in FIG. 8 describes how CPU 304 utilizes sensor status information to determine what content to show on the forward-facing (visible) display panels. Depending on whether a sensor is open or closed, the CPU displays or removes content from a particular display panel (Blocks 805, 810, 815, and 820). CPU 304 regularly checks the status of each sensor in a loop configuration (Blocks 825 and 830). In addition, CPU 304 regularly checks whether an input command (e.g., the pressing of an input button) has been issued by the user (Blocks 835 and 840). When an input command has been received at 840, CPU 304 advances the content on the visible display panels so that content for the subsequent panel(s) is displayed on the visible panels (Block 845). For example, in the vertical configuration (see FIG. 1B), CPU 304 replaces, on display panels 102 and 106, content from left-side quadrants “A” and “C” of the source content with content from right-side quadrants “B” and “C” of the source content that would have been displayed on display panels 104 and 108 if the device were unfolded in its broadsheet configuration. With a subsequent issuance of the input command (e.g., another press of the input button), CPU 304 replaces, on display panels 102 and 106, the currently displayed content associated with quadrants “B” and “D with the content corresponding to quadrants “A” and “C” of a subsequent page or portion of the source content item, and so forth.

In some embodiments, the unused display panels (e.g., those hidden from the view of a user looking at the front side of the device) described above may be filled with general advertising content aimed at individuals in near proximity to the device's user. In this situation CPU 304, having removed content from a particular display panel, gathers advertising content from a database and displays the obtained advertising content on that panel.

### V. Advancing to the Continuation of an Article

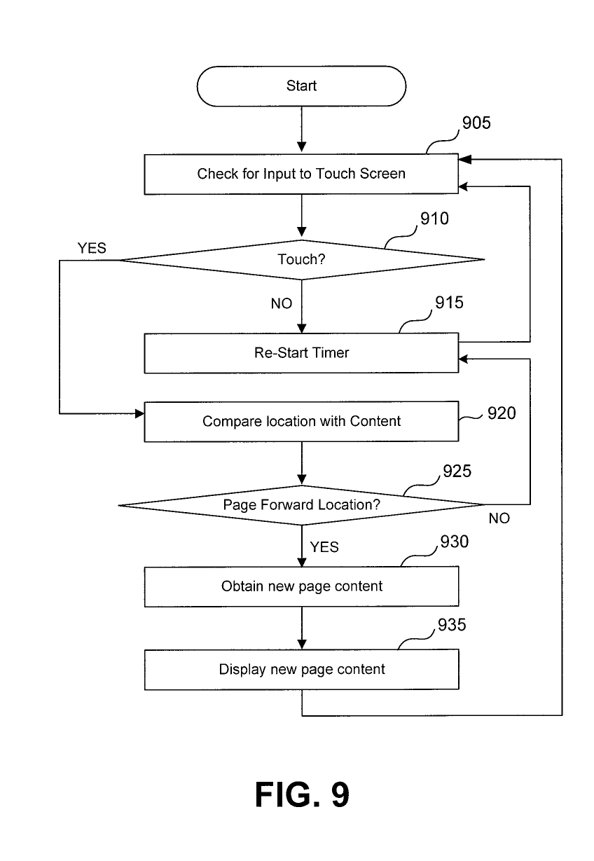

FIG. 9 is a flowchart of a method for obtaining new content to be displayed on a portable electronic device in accordance with an illustrative embodiment of the invention. FIG. 9 illustrates a process by which CPU 304 decides whether to advance the content displayed to the page where the content item (e.g., an article) is continued. In this embodiment, CPU 304 periodically and repeatedly checks the circuits on touch screen 410 to determine if an input has occurred (Blocks 905, 910, and 915). If an input has occurred, CPU 304 checks against its data store to determine if the touched location corresponds to a hyperlink that points to a continuation of the displayed content item (Blocks 920 and 925). If the input is not related to some content, then the CPU ignores the input (Block 925). If the input is related to a hyperlinked continuation, then the CPU erases the existing displayed content and replaces it with the content of the page where the content item is continued (Blocks 930 and 935).

In other embodiments, a user may navigate to a subsequent portion of an article without the use of a touch screen 410. For example, the device may include one or more navigation buttons for that purpose.

### VI. Enlarging the Size of the Displayed Content

In some embodiments, the portable electronic device may utilize the combination of a button push (see control module 210 in FIG. 2) and an input to touch screen 410 to determine that the user wishes for a particular article to be enlarged or that the user desires to return to a display of the full page of the content (e.g., a newspaper page).

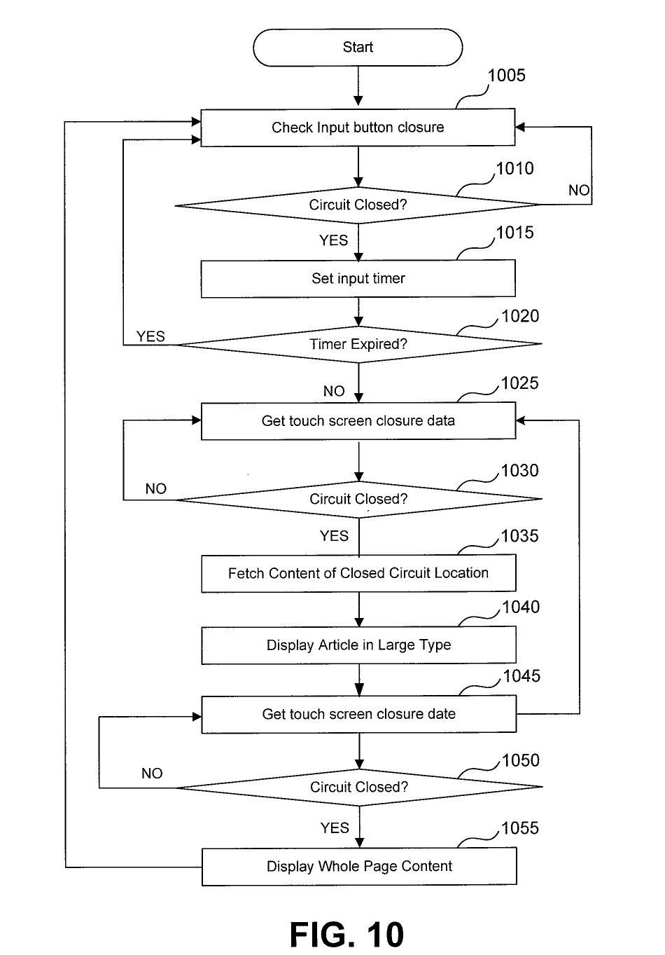

FIG. 10 is a flowchart of a method for enlarging, in response to input from a user, content displayed on a portable electronic device in accordance with an illustrative embodiment of the invention. FIG. 10 illustrates a process by which CPU 304 determines whether to enlarge the displayed content. In this particular embodiment, enlarging the content requires two user inputs within a defined period of time for both of them. At 1005 and 1010, CPU 304 checks for a button-push input or other predetermined input by the user. When such an input occurs, the CPU 304 starts a timer and then checks for a touch-screen input (Blocks 1015, 1020, 1025, and 1030). If the touch-screen input does not occur within the timer period, then the sequence aborts and the CPU 304 again looks for a button input at 1005 and 1010. If a touch-screen input occurs within the timer period at 1020, CPU 304 checks its database to determine which portion of the displayed content (e.g., a particular article) the user has touched (Block 1035). CPU 304 then clears the complete page content and replaces it with an enlarged display of the chosen content portion (Block 1040). The CPU then repeatedly checks for a button input or other input signal and, when that occurs, CPU 304 replaces the enlarged content with the full-page content (Blocks 1045, 1050, and 1055).

### VII. Tailored Advertising

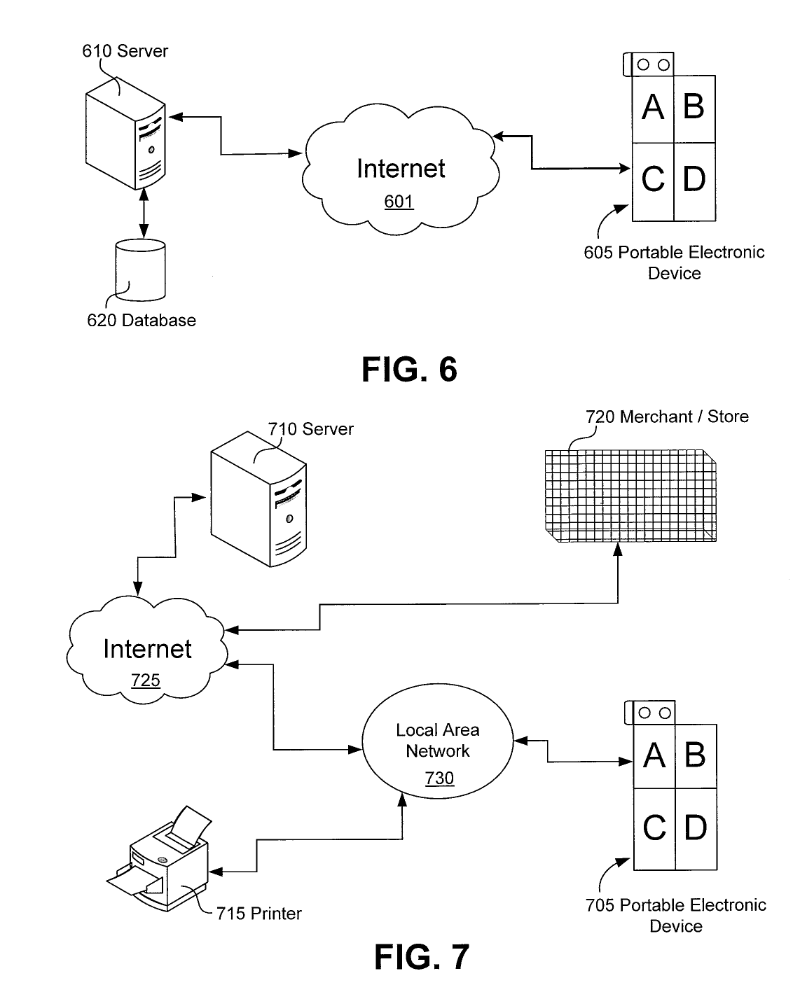

FIG. 6 is a high-level diagram of an environment in which a portable electronic device 605 is connected with a network server 610 and database 620 via the Internet 601 in accordance with an illustrative embodiment of the invention. As illustrated in FIG. 6, portable electronic device 605 receives content via a connection over the Internet 601 to a server 610 and database 620 at a data center. Periodically or as needed, portable electronic device 605 sends a request to the server 610. Portable electronic device 605 checks available files on server 610 against files stored on portable electronic device 605 and, if a file is missing on portable electronic device 605, portable electronic device 605 requests that server 610 serve the file to portable electronic device 605. In an embodiment in which portable electronic device 605 receives electronic newspaper content, the downloaded files include both the newspaper content formatted in the same manner as in a paper edition of the newspaper and advertisements that are included with various pages of the electronic newspaper.

In this embodiment, information is taken into account on the particular characteristics of the user based on, for example, answers to questions that the user supplies when subscribing to the service. One example of such a question is the user's address. Additional information about the user may be found by mining information about the user based on the user's interactions with the service. Based on this information, server 610, in some embodiments, replaces the original newspaper advertising content with new content that is tailored to the individual user's stored profile. In one embodiment, these customized advertisements are displayed in the same layout locations as the non-customized advertisements in the printed newspaper.

### VIII. Provision of Coupons on the Electronic Reader

As discussed above, the composite display of a portable electronic device in accordance with an illustrative embodiment of the invention may include one or more touch-sensitive display panels. When a user touches the touch screen 410 (see FIG. 4) above the place where the content displayed shows a coupon or other economic incentive, CPU 304 recognizes the touch and, after determining the content being selected, presents the user with a touch-screen dialog box requesting that the user choose the desired course of action from among a plurality of choices.

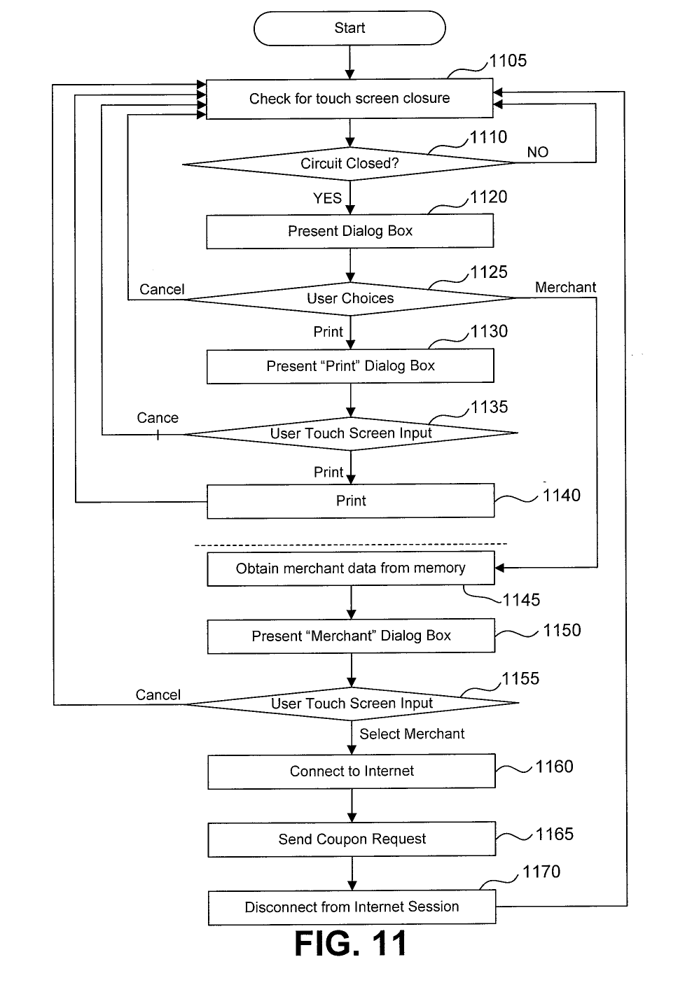

The physical arrangement is illustrated in FIG. 7, and the CPU's decision process is summarized in FIG. 11. FIG. 7 is a high-level diagram of an environment in which a portable electronic device 705 is connected with a local printer 715, a remote merchant location 720, or both in accordance with an illustrative embodiment of the invention. In FIG. 7, portable electronic device 705 is connected, via local area network (LAN) 730, to printer 715. Via LAN 730 and Internet 725, portable electronic device 705 is also in communication with server 710 and merchant/store 720. In some embodiments, the connection between portable electronic device 705 and either printer 715 or merchant/store 720 may be absent. For example, in some embodiments, the economic incentive is printed to a local printer 715 and physically carried to a merchant's store. Likewise, in other embodiments, there is no connected printer 715, and the user sends an electronic message to merchant/store 720 requesting redemption of the economic incentive at some future time (e.g., the next time the user visits the merchant's store). In still other embodiments, the user has the option of printing the economic incentive to a local printer 715 or sending the redemption request to the merchant/store 720.

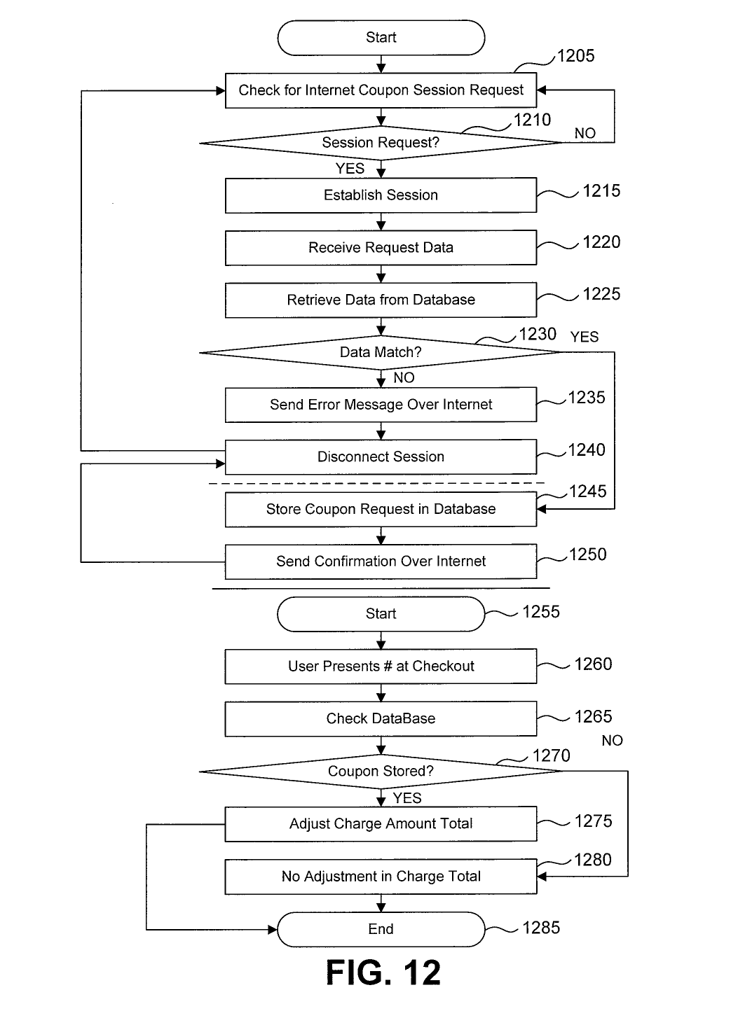

FIG. 11 is a flowchart of a method for processing, in a portable electronic device 705, a request from a user to redeem an economic incentive from a merchant in accordance with an illustrative embodiment of the invention. (A) If the user chooses the choice “cancel” (Blocks 1105, 1110, 1120, and 1125), CPU 304 returns to its normal monitoring state at 1105. (B) Should the user select the option “Printer,” CPU 304 presents the user with a “Print” dialog box and prints the coupon on a local printer (Blocks 1130, 1135, and 1140). Should the user not be in range of an established printer, then the CPU stores the print request and automatically prints the coupon the next time portable electronic device 705 is linked to an established printer (Block 1140). (C) If the user selects “Merchant” at 1125, then the CPU sends via the Internet the user request to the sponsoring merchant (720) for processing (Blocks 1145, 1150, 1155, 1160, 1165, and 1170). The user's pending request to redeem the coupon is stored in the merchant's computer. When the user next visits the merchant and presents his or her user identification number (i.e., once the store's point-of-sale computer has authenticated the user), the store's point-of-sale computer system recognizes the user and automatically adjusts the checkout charges by the amount of the coupon or other economic incentive. This portion of the process is summarized in FIG. 12.

FIG. 12 is a flowchart of a method for processing, in a merchant's point-of-sale system, a request to redeem an economic incentive received from a portable electronic device 705 in accordance with an illustrative embodiment of the invention. Once the merchant's computer has recognized a coupon-session request and has established a coupon session with portable electronic device 705, the merchant's computer receives the portable-device user's redemption request, verifies the validity of the coupon or other economic incentive, and responds accordingly (Blocks 1205, 1210, 1215, 1220, 1225, 1230, 1235, and 1240). At 1245, the merchant's computer stores the coupon redemption request in a database and, at 1250, sends confirmation back to portable electronic device 705.

The process of applying the stored coupon redemption request to a portable-device-user purchase begins at 1255. At 1260, the user of the portable electronic device 705 presents his or her identification number at checkout. The merchant's point-of-sale computer checks the identification number against its database at 1265. If a pending coupon redemption for the identified portable-device user is found at 1270, the total amount of the user's purchase is automatically adjusted in accordance with the coupon at 1275. Otherwise, if no pending economic-incentive requests are found at 1270, no adjustment is made at 1280. At 1285, the process terminates.

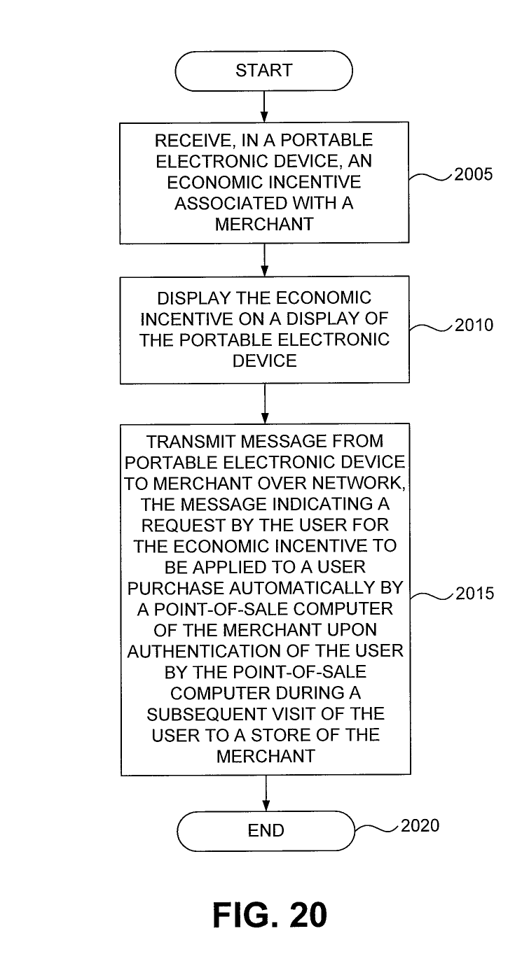

FIG. 20 is a flowchart of a method for redeeming an economic incentive in accordance with an illustrative embodiment of the invention. At 2005, a portable electronic device receives an economic incentive such as a coupon that is associated with a merchant. At 2010, the portable electronic device displays the economic incentive on its display. In some embodiments, the display is a composite display made up of multiple separate display panels, as described above. In some embodiments, the display, whether composite or unitary, may include a touch screen 410. In response to the portable-device user's selection of the economic incentive (e.g., by touching it on a touch-sensitive display), the portable electronic device, at 2015, transmits a message to the merchant's computer over a network. The transmitted message, in this embodiment, indicates a request by the user for the economic incentive to be applied to a user purchase automatically by a point-of-sale computer of the merchant upon authentication of the user by the point-of-sale computer during a subsequent visit of the user to the merchant's store, whether the store is physical or virtual (e.g., on the World Wide Web). At 2020, the process terminates.

### IX. Input Controls

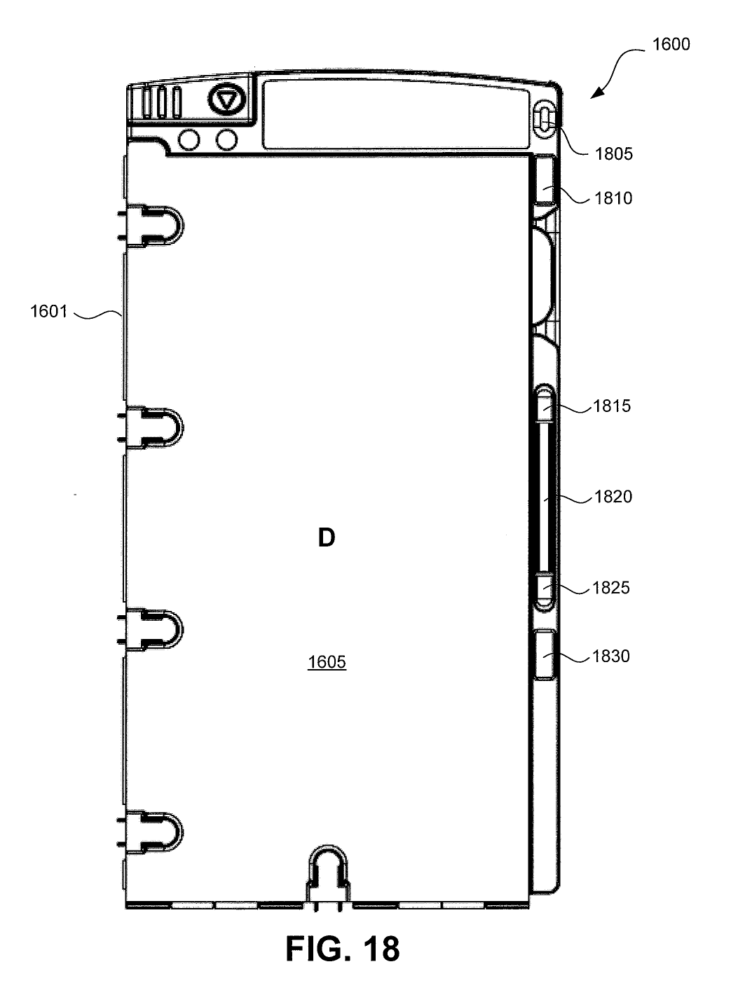

FIG. 18 is a front view of a portable electronic device 1600 showing a set of input controls for controlling the operation of the device in accordance with another illustrative embodiment of the invention. Portable electronic device 1600 includes a menu button 1805 for invoking on composite display 1601 a menu associated with the device's user interface. Zoom button 1810 allows the user to enlarge or reduce content on composite display 1601. In one embodiment, zoom button 1810 is a rocker button by which content is enlarged when the user actuates the upper portion of the rocker button and by which content is reduced (or returned its default size) when the lower portion of the rocker button is actuated.

“Up” navigation button 1815 and “down” navigation button 1825 allow the user to scroll the displayed content up or down by one display panel, respectively. The user may push (displace slightly) navigation bar 1820 to the right or to the left to advance the content or to go back within the content, respectively. Back/home button 1830 returns composite display 1601 to an earlier context (e.g., the previous page or portion of a page viewed). In general, the “back” aspect of this control backs the context of the device up by one step for each actuation of the control. Back/home button 1830 is also used to return the composite display 1601 to a predetermined point in the content (e.g., the first page of an electronic newspaper to which the user subscribes). In one embodiment, back/home button 1830 is a rocker button similar to zoom button 1810 described above, the bottom portion of which corresponds to “back,” the top portion of which corresponds to “home.”

The input controls described above in connection with FIGS. 2 and 18 are merely examples. As those skilled in the art will recognize, many other user-interface variations are possible. For example, the embodiment depicted in FIG. 18 may include a touch-screen user interface, as described above in connection with FIG. 4.

In conclusion, the present invention provides, among other things, a method and apparatus for redeeming an economic incentive. Those skilled in the art can readily recognize that numerous variations and substitutions may be made in the invention, its use, and its configuration to achieve substantially the same results as achieved by the embodiments described herein. Accordingly, there is no intention to limit the invention to the disclosed illustrative forms. Many variations, modifications, and alternative constructions fall within the scope and spirit of the disclosed invention as expressed in the claims.

What is claimed is:

1. A method for redeeming an economic incentive, the method comprising:
receiving in a portable electronic device an economic incentive associated with a merchant;
displaying the economic incentive on a display of the portable electronic device; and
transmitting over a network a message from the portable electronic device to a computer associated with the merchant in response to a user's selection of the displayed economic incentive, the message indicating a request by the user for the economic incentive to be applied to a user purchase automatically by a point-of-sale computer of the merchant upon authentication of the user by the point-of-sale computer during a subsequent visit of the user to a store of the merchant.

2. The method of claim 1, wherein the economic incentive is a coupon.

3. The method of claim 1, wherein the store is a physical store.

4. The method of claim 1, wherein authentication of the user by the point-of-sale computer includes verifying a user identification number associated with the user.

5. The method of claim 1, wherein the user selects the economic incentive via a touch-screen user interface of the portable electronic device.

6. The method of claim 1, wherein at least a portion of the network is wireless.

7. The method of claim 1, wherein the display is a composite display that includes a plurality of separate display panels joined by at least one hinging mechanism to enable the composite display to be folded and unfolded into a plurality of configurations, the at least one hinging mechanism causing any two adjacent display panels in the plurality of separate display panels, when arranged so as to be in the same plane, to be substantially flush along their adjacent edges to emulate the appearance of an uninterrupted display across the adjacent edges.

8. The method of claim 1, wherein the display is a composite display that includes four separate display panels flexibly joined in a two-by-two arrangement by a set of hinging mechanisms to enable the composite display to be folded and unfolded into at least four distinct configurations, the at least four distinct configurations including a first configuration in which the composite display is folded to the width and height dimensions of a single display panel among the four separate display panels, a second configuration in which the composite display is folded along a horizontal seam to be two display panels wide by one display panel high, a third configuration in which the composite display is folded along a vertical seam to be two display panels high by one display panel wide, and a fourth configuration in which all four separate display panels are unfolded so as to be in a single plane, the set of hinging mechanisms causing any two adjacent display panels among the four separate display panels, when arranged so as to be in the same plane, to be substantially flush along their adjacent edges to emulate the appearance of an uninterrupted display across the adjacent edges.

9. A method for redeeming an economic incentive, the method comprising:
receiving in a portable electronic device an economic incentive associated with a merchant;
displaying the economic incentive on a display of the portable electronic device;
presenting on the display a plurality of options in response to a user's selection of the economic incentive;
printing the economic incentive in response to the user's selection of a first option in the plurality of options when the portable electronic device is in communication with a printer;
storing a request to print the economic incentive in response to the user's selection of the first option when the portable electronic device is not in communication with a printer and automatically printing the economic incentive when the portable electronic device is subsequently in communication with a printer; and
transmitting over a network, in response to the user's selection of a second option in the plurality of options, a message from the portable electronic device to a computer associated with the merchant, the message indicating a request by the user for the economic incentive to be applied to a user purchase automatically by a point-of-sale computer of the merchant upon authentication of the user by the point-of-sale computer during a subsequent visit of the user to a store of the merchant.

10. The method of claim 9, wherein the display is a composite display that includes a plurality of separate display panels joined by at least one hinging mechanism to enable the composite display to be folded and unfolded into a plurality of configurations, the at least one hinging mechanism causing any two adjacent display panels in the plurality of separate display panels, when arranged so as to be in the same plane, to be substantially flush along their adjacent edges to emulate the appearance of an uninterrupted display across the adjacent edges.

11. The method of claim 9, wherein the display is a composite display that includes four separate display panels flexibly joined in a two-by-two arrangement by a set of hinging mechanisms to enable the composite display to be folded and unfolded into at least four distinct configurations, the at least four distinct configurations including a first configuration in which the composite display is folded to the width and height dimensions of a single display panel among the four separate display panels, a second configuration in which the composite display is folded along a horizontal seam to be two display panels wide by one display panel high, a third configuration in which the composite display is folded along a vertical seam to be two display panels high by one display panel wide, and a fourth configuration in which all four separate display panels are unfolded so as to be in a single plane, the set of hinging mechanisms causing any two adjacent display panels among the four separate display panels, when arranged so as to be in the same plane, to be substantially flush along their adjacent edges to emulate the appearance of an uninterrupted display across the adjacent edges.

12. A portable electronic device, comprising:
a display;
a processor;
at least one communication interface; and
a plurality of program instructions stored in a memory and executable by the processor that are configured to cause the processor to:
receive, via the at least one communication interface, an economic incentive associated with a merchant;
display the economic incentive on the display; and
transmit over a network a message from the portable electronic device to a computer associated with the merchant in response to a user's selection of the displayed economic incentive, the message indicating a request by the user for the economic incentive to be applied to a user purchase automatically by a point-of-sale computer of the merchant upon authentication of the user by the point-of-sale computer during a subsequent visit of the user to a store of the merchant.

13. The portable electronic device of claim 12, wherein the economic incentive is a coupon.

14. The portable electronic device of claim 12, wherein the store is a physical store.

15. The portable electronic device of claim 12, wherein authentication of the user by the point-of-sale computer includes verifying a user identification number associated with the user.

16. The portable electronic device of claim 12, wherein the display is touch sensitive and the plurality of program instructions are configured to cause the processor to support a touch-responsive user interface.

17. The portable electronic device of claim 12, wherein at least a portion of the network is wireless.

18. The portable electronic device of claim 12, wherein the display is a composite display that includes a plurality of separate display panels joined by at least one hinging mechanism to enable the composite display to be folded and unfolded into a plurality of configurations, the at least one hinging mechanism causing any two adjacent display panels in the plurality of separate display panels, when arranged so as to be in the same plane, to be substantially flush along their adjacent edges to emulate the appearance of an uninterrupted display across the adjacent edges.

19. The portable electronic device of claim 12, wherein the display is a composite display that includes four separate display panels flexibly joined in a two-by-two arrangement by a set of hinging mechanisms to enable the composite display to be folded and unfolded into at least four distinct configurations, the at least four distinct configurations including a first configuration in which the composite display is folded to the width and height dimensions of a single display panel among the four separate display panels, a second configuration in which the composite display is folded along a horizontal seam to be two display panels wide by one display panel high, a third configuration in which the composite display is folded along a vertical seam to be two display panels high by one display panel wide, and a fourth configuration in which all four separate display panels are unfolded so as to be in a single plane, the set of hinging mechanisms causing any two adjacent display panels among the four separate display panels, when arranged so as to be in the same plane, to be substantially flush along their adjacent edges to emulate the appearance of an uninterrupted display across the adjacent edges.

20. The portable electronic device of claim 12, wherein the at least one communication interface includes at least one of a wireless personal area network (PAN) transceiver, a wireless local area network (WLAN) transceiver, a broadcast radio receiver, an Ethernet port, and a Universal Serial Bus (USB) port.

21. A portable electronic device, comprising:
a display;
a processor;
at least one communication interface; and
a plurality of program instructions stored in a memory and executable by the processor that are configured to cause the processor to:
receive, via the at least one communication interface, an economic incentive associated with a merchant;
display the economic incentive on the display;
present on the display a plurality of options in response to a user's selection of the economic incentive;
print the economic incentive in response to the user's selection of a first option in the plurality of options when the portable electronic device is in communication with a printer;
store a request to print the economic incentive in response to the user's selection of the first option when the portable electronic device is not in communication with a printer and automatically print the economic incentive when the portable electronic device is subsequently in communication with a printer; and
transmit over a network, in response to the user's selection of a second option in the plurality of options, a message from the portable electronic device to a computer associated with the merchant in response to a user's selection of the displayed economic incentive, the message indicating a request by the user for the economic incentive to be applied to a user purchase automatically by a point-of-sale computer of the merchant upon authentication of the user by the point-of-sale computer during a subsequent visit of the user to a store of the merchant.

22. The portable electronic device of claim 21, wherein the display is a composite display that includes a plurality of separate display panels joined by at least one hinging mechanism to enable the composite display to be folded and unfolded into a plurality of configurations, the at least one hinging mechanism causing any two adjacent display panels in the plurality of separate display panels, when arranged so as to be in the same plane, to be substantially flush along their adjacent edges to emulate the appearance of an uninterrupted display across the adjacent edges.

23. The portable electronic device of claim 21, wherein the display is a composite display that includes four separate display panels flexibly joined in a two-by-two arrangement by a set of hinging mechanisms to enable the composite display to be folded and unfolded into at least four distinct configurations, the at least four distinct configurations including a first configuration in which the composite display is folded to the width and height dimensions of a single display panel among the four separate display panels, a second configuration in which the composite display is folded along a horizontal seam to be two display panels wide by one display panel high, a third configuration in which the composite display is folded along a vertical seam to be two display panels high by one display panel wide, and a fourth configuration in which all four separate display panels are unfolded so as to be in a single plane, the set of hinging mechanisms causing any two adjacent display panels among the four separate display panels, when arranged so as to be in the same plane, to be substantially flush along their adjacent edges to emulate the appearance of an uninterrupted display across the adjacent edges.
